(19) United States
(12) Patent Application Publication
(10) Pub. No.: US 2025/0368449 A1
(43) Pub. Date: Dec. 4, 2025

(54) BATCH PICKING INTERFACE

(71) Applicant: AutoStore Technology AS, Nedre Vats (NO)

(72) Inventors: Erik LUNDSTRÖM, Asker (NO); Øystein GJERDEVIK, Skjold (NO)

(21) Appl. No.: 18/875,485

(22) PCT Filed: Aug. 23, 2023
(86) PCT No.: PCT/EP2023/073169

§ 371 Date: Dec. 16, 2024

(30) Foreign Application Priority Data
Aug. 25, 2022 (NO) 20220908

(51) Int. Cl. B65G 1/137; B65G 1/04; G06Q 10/087

(52) U.S. Cl. CPC B65G 1/1378; B65G 1/0464; G06Q 10/08741; B65G 2209/02

(57) ABSTRACT

A method for optimising the picking of items from containers at a port of an automated storage and retrieval system comprising a framework structure (100) forming a three-dimensional storage grid structure (104) for storing storage containers (106) for storing items, where the grid structure (104) forms vertical storage columns (105) each having a horizontal area defined by the size of an access opening (112) of the vertical storage columns (105) and where the framework structure comprises a rail system (108) arranged above the storage columns (105), the rail system comprising a plurality of rails extending in an X-direction and a Y-direction to form a grid, the rails defining a perimeter of each access opening (112) on top of each storage column (105), the rail system (108) providing available routes in the X-direction or the Y-direction for container handling vehicles (201, 301) handling and transferring the storage containers (106) to and from the storage columns (105), wherein the method comprises the following steps; presenting the central computer system with a queue of tasks, reconfiguring the queue of tasks that can share sorting container with another orders, setting the container queue at the port based on the inventory inside a container/container compartment in such a way that when one container is presented it gets the maximum amount of pick to destination containers.

### FIELD OF THE INVENTION

The present invention relates to an automated storage and retrieval system for storage and retrieval of containers, in particular to a method for picking of items from containers at a port of an automated storage and retrieval system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as containers, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a, 401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

In todays solution the orders of items come from the customer into the central computer system. the order is sent on to the computer program that handles the picking of the containers that has the items in them. The containers are picked up by the container handling vehicles and transported to the port for picking. After picking the items from the containers the containers are sent back into the storage and retrieval unit. A drawback from this solution is that the system does not take into account that there might be several orders that has the same items for picking.

As an example, consider Order A and Order B. Order A requires items from source containers 1, 2 and 3. Order B requires items from source containers 1, 2, and 4. When packing Orders A and B, the following process would be followed:

Source container 1→Access station. Items removed for order A.

Source container 1→storage volume.

Source container 2→Access station. Items removed for order A.

Source container 2→storage volume.

Source container 3→Access station. Items removed for order A.

Source container 3→storage volume.

Source container 1→Access station. Items removed for order B.

Source container 1→storage volume.

Source container 2→Access station. Items removed for order B.

Source container 2→storage volume.

Source container 4→Access station. Items removed for order B.

Source container 4→storage volume.

WO2022043573 A1 discloses controlling of a picking device at a picking station for picking of products stored in storage containers of an automated storage and retrieval system. Storage containers to be picked from are transported from the automated storage and retrieval system to the picking station. The picking station is controlled by a picking system controller.

WO2021122218 A1 discloses a picking system that includes an area divided into sub-areas (positions to pick from and pick to) where the delivery of storage containers and/or packages to these sub-areas are controlled by an Automated Storage and Retrieval System (ASRS) control system, a camera, an image processing system and a picking device that operates within the area.

US2022106121 A1 discloses a system and method for controlling an automated warehouse or order fulfilment facility. The system includes a sequencing tower, and various pick/decant workstations which are connected between the sequencing tower and an automated storage and retrieval system (ASRS). The sequencing tower is adapted for receiving, storing, and releasing newly erected shipping containers and inbound vendor cases. The pick/decant workstations function as a hub between the sequencing tower and the ASRS, where operators at the pick/decant workstations pick order items to shipping containers to fulfil orders or pick inbound/vendor items to inventory containers to be stored in the ASRS.

So as described here there are drawbacks with doing it this way, it is a slow way of handling the orders, since the containers has to go back into the storage and retrieval unit between every picking.

### SUMMARY OF THE INVENTION

The present invention is set forth and characterized in the independent claims, while the dependent claims describe other characteristics of the invention.

In one aspect, the invention is related to a method for picking of items from containers at a port of an automated storage and retrieval system comprising a framework structure (100) forming a three-dimensional storage grid structure (104) for storing storage containers (106) for storing items, where the grid structure (104) forms vertical storage columns (105) each having a horizontal area defined by the size of an access opening (112) of the vertical storage columns (105) and where the framework structure comprises a rail system (108) arranged above the storage columns (105), the rail system comprising a plurality of rails extending in an X-direction and a Y-direction to form a grid, the rails defining a perimeter of each access opening (112) on top of each storage column (105), the rail system (108) providing available routes in the X-direction or the Y-direction for container handling vehicles (201, 301) handling and transferring the storage containers (106) to and from the storage columns (105), wherein the method comprises the following steps; presenting the controller with a plurality of orders, reconfiguring the queue of tasks that can share sorting container with another order, setting the container queue at the port based on the inventory inside a container in such a way that when one container is presented at the port it gets the maximum amount of pick to destination containers.

Further, a port can have a category for picking a certain set of inventories from containers.

Also, when distributing orders to this port, orders can share containers sent to the container queue of the port, comprising grouping orders as task groups to share containers before setting the port container queue, and comprising grouping content in containers that is usually picked to the same order.

A Warehouse Management Service (WMS) organizes the queue of containers.

A method for picking of items from containers at a port of an automated storage and retrieval system, comprising: retrieving a plurality of orders; determining the items in each order; for each item, determining a storage container in the automated storage and retrieval system which holds the item; associating each order with the storage container(s) which will be accessed to obtain the items to fulfil the order; grouping together orders which require access to a common storage container; ordering the common storage containers into a container queue to be brought to the port; presenting a common storage container from the queue at the port;

A method for picking of items from containers at a port of an automated storage and retrieval system, comprising: retrieving a plurality of orders; determining the items in each order; for each item, determining a storage container in the automated storage and retrieval system which holds the item, associating each order with the storage container(s) which will be accessed to fulfil the order; presenting a storage container at the port; searching the plurality of orders for orders which require items from the presented storage container; picking items from the storage container into each order which requires items from the storage container. Also, picking items from the common storage container into each order which requires items from the common storage container.

In a second aspect, the invention concerns a computer program product, comprising a program configured to carry out the method defined above.

A third aspect the invention is directed to an automated storage and retrieval system comprising a framework structure (100) forming a three-dimensional storage grid structure (104) for storing storage containers (106) for storing items, where the grid structure (104) forms vertical storage columns (105) each having a horizontal area defined by the size of an access opening (112) of the vertical storage columns (105) and where the framework structure comprises a rail system (108) arranged above the storage columns (105), the rail system comprising a plurality of rails extending in an X-direction and a Y-direction to form a grid, the rails defining a perimeter of each access opening (112) on top of each storage column (105), the rail system (108) providing available routes in the X-direction or the Y-direction for container handling vehicles (201, 301) handling and transferring the storage containers (106) to and from the storage columns (105), and a controller, wherein the controller is configured to carry out the method defined above.

As described here this solution allows the items in the container to be picked for several orders and the container does not have to be sent back into the storage and retrieval unit for every item that has to be picked from the container handling vehicle. this allows for the system to handle more orders to be picked in a certain period of time and the system is more efficient.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a flow chart describing the present invention.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

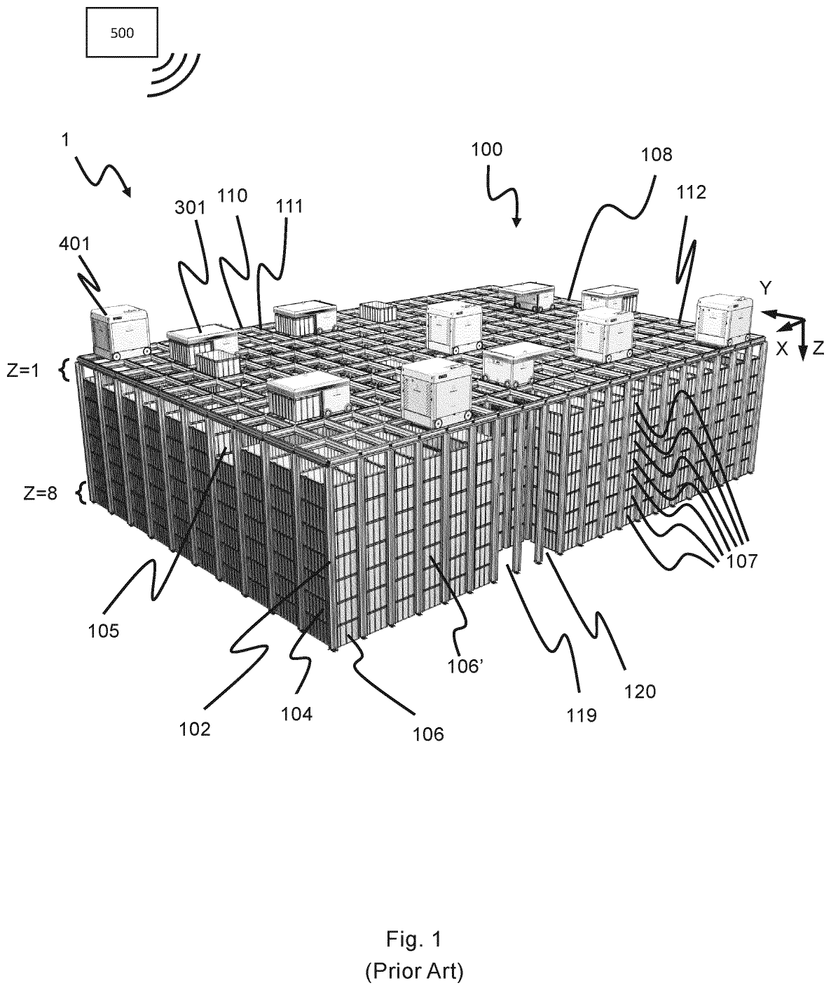

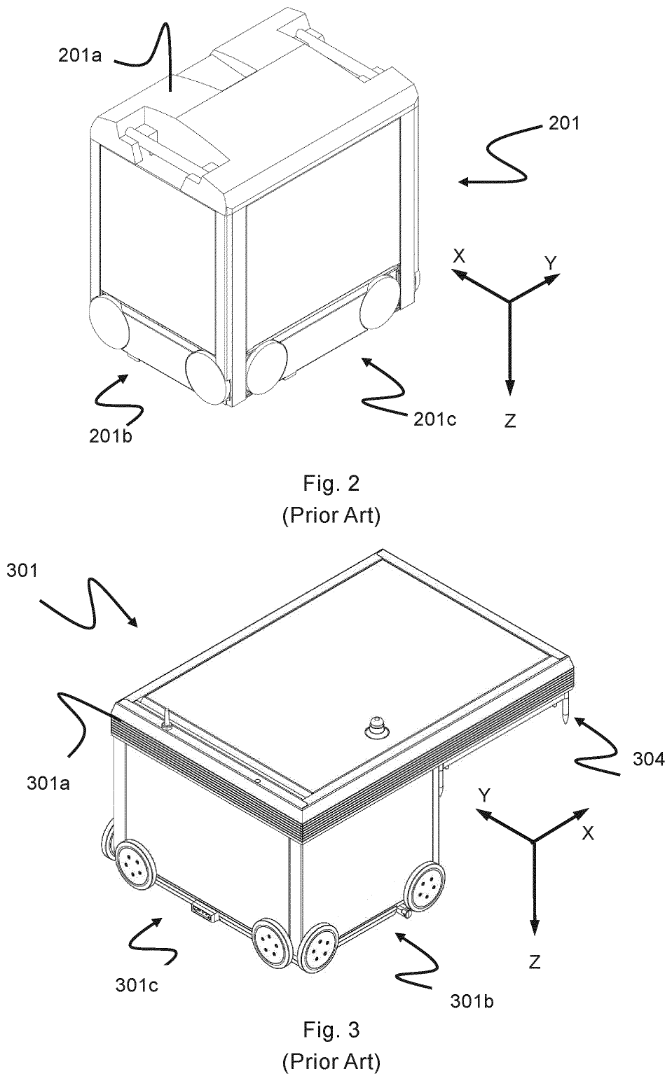

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

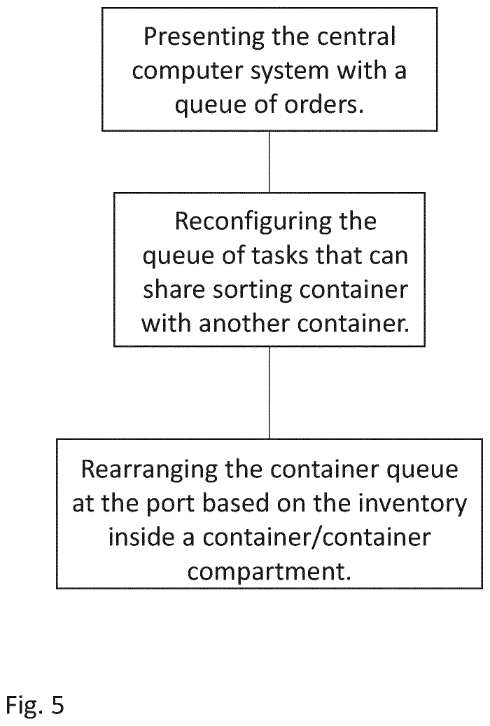

One embodiment of the automated storage and retrieval system according to the invention will now be discussed in more detail with reference to FIG. 5.

FIG. 5 is a flow chart describing the present invention.

The present invention reconfigures orders to use different containers in real time. As new containers are assigned to the port, the orders to be picked in the port are re-evaluated to use the new incoming containers/existing containers. The container queue in the port could also be reordered to better fit the simultaneous picking of the orders. This will require the logic to be aware of the container content.

In the present invention the central computer system is presented with list of orders that needs to be fulfilled. Instead of sending the container back to the storage and retrieval system every time a container is finished being picked at the port, the present invention will group as many orders that has the same items for picking from one container as possible. So, the person or robot that is doing the picking at the port will collect items for a plurality of orders to from the same container. The orders can be picked into the same destination container. The destination container is the container that is the person or the robot that is doing the picking is placing the picking items into. The source container is the container the container that the person or the robot that is picking the items is picking from.

In order to do this style of picking easier the container handling vehicles with the containers that are waiting to drop of the containers can be rearranged in the order that is most suitable for the picking of a particular group of orders.

As new containers are assigned to the port, the orders to be picked in the port are re-evaluated to use the new incoming containers/existing containers. The container queue in the port could also be reordered to better fit the simultaneous picking of the orders.

If this information is feed to system this enables it to analyze the queue and arrange it in such a way that when one source container is presented at the port it gets the maximum number of picks to destination containers.

In addition, a port could have a category with a certain set of inventory items. When distributing orders to this port, orders could share containers sent to the container queue of the port. Orders could be grouped as task groups to share containers before setting the port container queue.

### Example 1

This is an example of how the list of orders and the arranging of the containers from the storage and retrieval unit is arranged in order to maximize the picking from the containers.

In order for this method to work, we need to know:
The items in each order;
The storage container (source container) in which each item is located.

It is then possible to group orders together which all require access to the same storage container, and process them simultaneously.

There is then a question of how the grouping is done.

In a first method, one order acts as a “master order”-that order is picked from start to finish. it is called Order M. Order M requires access to containers 1, 2 and 3. Order A requires access to containers 2, 3 and 4. Order B requires access to containers 2, 4 and 5.

The process would then be:

Source container 1→Access station. Items removed to target container for Order M. Controller checks whether Order A or B need items from container 1—they do not.

Source container 1→storage volume.

Source container 2→Access station. Items removed to target container for Order M. Controller checks whether Order A or B need items from container 2—they do. Items removed to target container for Order A, and target container for Order B.

Source container 2→storage volume.

Source container 3→Access station. Items removed to target container for Order M. Controller checks whether Order A or B need items from container 1-Order A does, Order B does not. Items removed to target container for Order A

Source container 3→storage volume.

At this stage, Order M has been fully picked. Order A then becomes the new “master order”

Source container 4→Access station. Items removed to target container for Order A. Controller checks whether Order B needs items from container 4-it does. Items removed to target container for Order B.

Source container 4→storage volume.

At this stage, Order M has been fully picked. Order B then becomes the new “master order” . . . and so on.

This method is an “on-the-fly” /“real-time” method. The picking order is driven by the containers necessary for picking each master order

### Example 2

This is another solution to optimizing the picking.

Order A requires access to containers 1, 2 and 3.

Order B requires access to containers 2, 3 and 4.

Order C requires access to containers 2, 4 and 5.

The controller determines that the following orders need items from the following containers:

Container 1: Order A

Container 2: Order A, Order B and Order C

Container 3: Order A and Order B

Container 4: Order B

Container 5: Order C

Each container can be brought to the port, and the necessary items removed.

Source container 1→Access station. Items removed for Order A.

Source container 1→storage volume.

Source container 2→Access station. Items removed for Order A and Order B and Order C.

Source container 2→storage volume.

Source container 3→Access station. Items removed for Order A and Order B.

Source container 3→storage volume.

Source container 4→Access station. Items removed for Order B.

Source container 4→storage volume.

Source container 5→Access station. Items removed for Order C.

Source container 5→storage volume.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

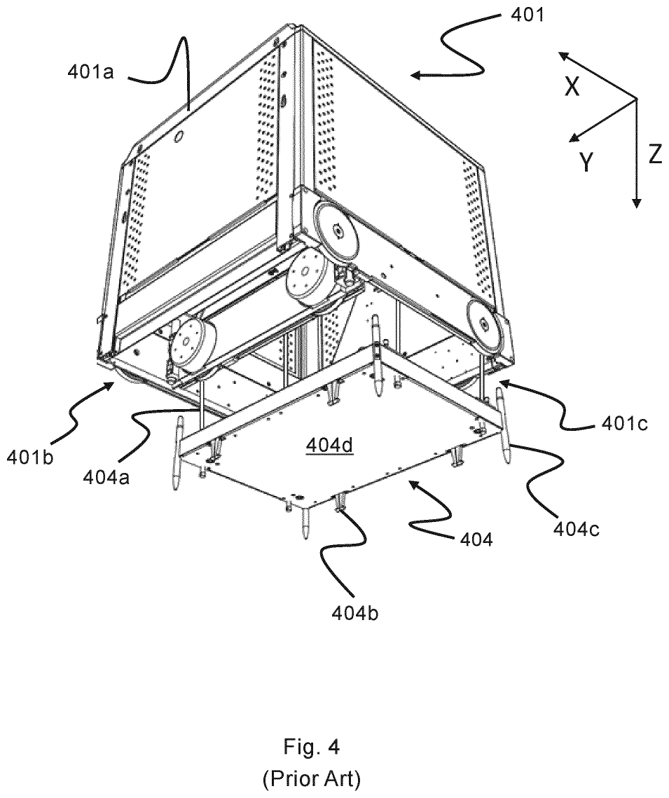

### Prior Art (FIGS. 1-4)

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction

1-11. (canceled)

12. A method for picking of items from containers at a port of an automated storage and retrieval system wherein the method comprises the following steps:
presenting a controller of the automated storage and retrieval system with a plurality of orders,
reconfiguring a queue of tasks that can share sorting container with another order,
setting the container queue at the port based on the inventory inside a container in such a way that when one container is presented at the port it gets the maximum amount of pick to destination containers.

13. The method according to claim 12, wherein the automated storage and retrieval system comprises a framework structure (100) forming a three-dimensional storage grid structure (104) for storing storage containers (106) for storing items, where the grid structure (104) forms vertical storage columns (105) each having a horizontal area defined by the size of an access opening (112) of the vertical storage columns (105) and where the framework structure comprises a rail system (108) arranged above the storage columns (105), the rail system comprising a plurality of rails extending in an X-direction and a Y-direction to form a grid, the rails defining a perimeter of each access opening (112) on top of each storage column (105), the rail system (108) providing available routes in the X-direction or the Y-direction for container handling vehicles (201, 301) handling and transferring the storage containers (106) to and from the storage columns (105),

14. The method according to claim 12, wherein a port has a category for picking a certain set of inventories from containers.

15. The method according to claim 14, wherein when distributing orders to this port, orders share containers sent to the container queue of the port.

16. The method according to claim 12, the method comprising grouping orders as task groups to share containers before setting the port container queue.

17. The method according to claim 12, the method comprising grouping content in containers that is usually picked to the same order.

18. The method according to claim 12, wherein a Warehouse Management Service (WMS) organizes the queue of containers.

19. A method for picking of items from containers at a port of an automated storage and retrieval system, comprising:
retrieving a plurality of orders;
determining the items in each order;
for each item, determining a storage container in the automated storage and retrieval system which holds the item;
associating each order with the storage container(s) which will be accessed to obtain the items to fulfil the order;
grouping together orders which require access to a common storage container;
ordering the common storage containers into a container queue to be brought to the port;
presenting a common storage container from the queue at the port;

20. A method for picking of items from containers at a port of an automated storage and retrieval system, comprising:
retrieving a plurality of orders;
determining the items in each order;
for each item, determining a storage container in the automated storage and retrieval system which holds the item,
associating each order with the storage container(s) which will be accessed to fulfil the order;
presenting a storage container at the port;
searching the plurality of orders for orders which require items from the presented storage container;
picking items from the storage container into each order which requires items from the storage container.

21. The method according to claim 20 wherein the method further comprises picking items from the common storage container into each order which requires items from the common storage container.

22. A computer program product, comprising a program configured to carry out the method defined by claim 12.

23. An automated storage and retrieval system comprising a controller, wherein the controller is configured to carry out the method defined by claim 12.

24. The automated storage and retrieval system of claim 12, further comprising a framework structure (100) forming a three-dimensional storage grid structure (104) for storing storage containers (106) for storing items, where the grid structure (104) forms vertical storage columns (105) each having a horizontal area defined by the size of an access opening (112) of the vertical storage columns (105) and where the framework structure comprises a rail system (108) arranged above the storage columns (105), the rail system comprising a plurality of rails extending in an X-direction and a Y-direction to form a grid, the rails defining a perimeter of each access opening (112) on top of each storage column (105), the rail system (108) providing available routes in the X-direction or the Y-direction for container handling vehicles (201, 301) handling and transferring the storage containers (106) to and from the storage columns (105).
